(19) United States
(12) Patent Application Publication
(10) Pub. No.: US 2008/0262771 A1
(43) Pub. Date: Oct. 23, 2008

(54) Statistic Analysis of Fault Detection and Classification in Semiconductor Manufacturing

(75) Inventors: Heung Seob Koo, Chungcheongbuk-do (KR); Jae Keun Lee, Daejeon (KR)

Correspondence Address: CANTOR COLBURN, LLP, 20 Church Street, 22nd Floor, Hartford, CT, 06103, US

(73) Assignee: ISEMICON, INC., Daejeon (KR)

(21) Appl. No.: 12/092,257

(22) PCT Filed: Nov. 1, 2006
(86) PCT No.: PCT/KR2006/004506

§ 371 Date: Apr. 30, 2008

(30) Foreign Application Priority Data
Nov. 1, 2005 (KR) 10-2005-0103590

(51) Int. Cl. G06F 19/00

(52) U.S. Cl. 702/82

(57) ABSTRACT

A method of fault detection and classification in semiconductor manufacturing is provided. In the method, delicate variations of actual data of parameters for which normal values of a manufacturing condition change according to time are detected very precisely and sensitively, and accordingly major variation components for a step which has a high occurrence occupancy are acquired to achieve a very precise and effective fault detection and classification (FDC). In the method, continuous steps in a process are regarded as separate processes which are not related to each other and covariance and covariance inverse matrixes acquired for each step are set as references to decrease values of variance or covariance compared with those for a case where references are calculated based on total steps. Accordingly, Hotelling's T-square values for a small variation are increased, so that a delicate variation can be sensitively detected.

### TECHNICAL FIELD

The present invention relates to semiconductor manufacturing, and more particularly, to a method of a statistical analysis of fault detection and classification in semiconductor manufacturing capable of detecting delicate variations of actual data of parameters for which normal values of a manufacturing condition change according to time.

### BACKGROUND ART

High technology facilities such as semiconductor fabrication equipments require tremendous costs for investments and over 75% of the costs correspond to equipment costs. Accordingly, various efforts have been made to improve an equipment usage ratio, and recently, technology for detecting a fault and classifying a cause of the fault by monitoring real time signals of equipment parameters is widely used. If parameters of equipment are to be controlled within normal values, it is required to acquire a trend of variations in values of the parameters. In order to acquire the trend of variations, a sensor for monitoring the variations in parameters may be attached, and values of the parameters according to time can be acquired through the sensor. In order to monitor actual values of parameters (multivariate), a current status of the equipment compared with a reference status can be acquired by using a statistical analysis. Generally, the monitoring values of the parameters are continuously performed in units of seconds, and there are over several tens of parameters to make the amount of data huge. And accordingly, it has been made possible to process the parameters using a statistical analysis when the computers are widely used recently.

Among statistical analysis methods, a method of multivariate variation detection using a Hotelling's T-square method will now be described. To more specifically, a method of multivariate variation detection for time series data made of subgroups will be described.

As shown in Table 1, there are six subgroups, and parameters P1, P2, and P3 exist for each subgroup. For each parameter, data for twelve different time points (m=12) is collected. The parameters P1, P2, and P3 have time series data for which normal values change according to each step m. The data is to be used as reference data for multivariate variation detection technology, and generation of reference data is called modeling. A method of modeling and multivariate variation detection according to general technology will now be described.

TABLE 1

| m | P1 | P2 | P3 | m | P1 | P2 | P3 | m | P1 | P2 | P3 |
|---|---|---|---|---|---|---|---|---|---|---|---|
| (a) Subgroup 1 | | | | (b) Subgroup 2 | | | | (c) Subgroup 3 | | | |
| 1 | 1 | 1 | 4 | 1 | 0 | 0 | 5 | 1 | 1 | 0 | 5 |
| 2 | 1 | 0 | 6 | 2 | 2 | 1 | 6 | 2 | 3 | 0 | 6 |
| 3 | 15 | 1 | 5 | 3 | 17 | 0 | 6 | 3 | 15 | 0 | 7 |
| 4 | 13 | 0 | 6 | 4 | 12 | 1 | 5 | 4 | 13 | 1 | 6 |
| 5 | 12 | 2 | 5 | 5 | 11 | 1 | 5 | 5 | 12 | 2 | 5 |
| 6 | 11 | 25 | 15 | 6 | 12 | 22 | 15 | 6 | 11 | 23 | 16 |
| 7 | 11 | 38 | 16 | 7 | 11 | 36 | 16 | 7 | 12 | 38 | 16 |
| 8 | 11 | 35 | 15 | 8 | 11 | 34 | 16 | 8 | 11 | 35 | 15 |
| 9 | 11 | 34 | 6 | 9 | 12 | 33 | 6 | 9 | 12 | 33 | 5 |
| 10 | 11 | 33 | 5 | 10 | 12 | 34 | 5 | 10 | 12 | 34 | 6 |
| 11 | 12 | 34 | 5 | 11 | 12 | 33 | 5 | 11 | 11 | 33 | 6 |
| 12 | 11 | 34 | 5 | 12 | 12 | 33 | 5 | 12 | 12 | 34 | 5 |
| (d) Subgroup 4 | | | | (e) Subgroup 5 | | | | (f) Subgroup 6 | | | |
| 1 | 1 | 1 | 4 | 1 | 0 | 0 | 5 | 1 | 1 | 0 | 5 |
| 2 | 1 | 0 | 6 | 2 | 2 | 1 | 6 | 2 | 3 | 0 | 6 |
| 3 | 15 | 1 | 5 | 3 | 17 | 0 | 6 | 3 | 15 | 0 | 7 |
| 4 | 13 | 0 | 6 | 4 | 12 | 1 | 5 | 4 | 13 | 1 | 6 |
| 5 | 12 | 2 | 5 | 5 | 11 | 1 | 5 | 5 | 12 | 2 | 5 |
| 6 | 11 | 25 | 15 | 6 | 12 | 22 | 15 | 6 | 11 | 23 | 16 |
| 7 | 11 | 38 | 16 | 7 | 11 | 36 | 16 | 7 | 12 | 38 | 16 |
| 8 | 11 | 35 | 15 | 8 | 11 | 34 | 16 | 8 | 11 | 35 | 15 |
| 9 | 11 | 34 | 6 | 9 | 12 | 33 | 6 | 9 | 12 | 33 | 5 |
| 10 | 11 | 33 | 5 | 10 | 12 | 34 | 5 | 10 | 12 | 34 | 6 |
| 11 | 12 | 34 | 5 | 11 | 12 | 33 | 5 | 11 | 11 | 33 | 6 |
| 12 | 11 | 34 | 5 | 12 | 12 | 33 | 5 | 12 | 12 | 34 | 5 |

In a first step of the general technology, total averages of six subgroups are calculated for each step (m). The result is shown in Table 2.

TABLE 2

| m | P1 | P2 | P3 |
|---|---|---|---|
| 1 | 0.67 | 0.33 | 4.50 |
| 2 | 2.00 | 0.33 | 5.67 |
| 3 | 15.83 | 0.50 | 6.00 |
| 4 | 12.83 | 0.67 | 5.83 |
| 5 | 11.83 | 2.00 | 5.33 |
| 6 | 11.33 | 23.33 | 15.67 |
| 7 | 11.50 | 37.83 | 16.33 |
| 8 | 11.17 | 35.33 | 15.50 |
| 9 | 11.50 | 33.67 | 5.67 |
| 10 | 11.50 | 33.33 | 5.33 |
| 11 | 11.67 | 33.50 | 5.50 |
| 12 | 11.50 | 33.50 | 5.33 |

In a second step, deviations from the averages in Table 2 for each subgroup are calculated, and covariance matrixes are generated. The result is shown in Table 3.

TABLE 3

| | | | | | | |
|---|---|---|---|---|---|---|
| m | P1 | P2 | P3 | P1 | P2 | P3 |

(a) Deviation and Covariance Matrix for subgroup 1

| | | | | | | | |
|---|---|---|---|---|---|---|---|
| 1 | −0.33 | −0.67 | 0.50 | P1 | 0.20 | 0.01 | −0.02 |
| 2 | 1.00 | 0.33 | −0.33 | P2 | 0.01 | 0.39 | −0.13 |
| 3 | 0.83 | −0.50 | 1.00 | P3 | −0.02 | −0.13 | 0.16 |
| 4 | −0.17 | 0.67 | −0.17 | | | | |
| 5 | −0.17 | 0.00 | 0.33 | | | | |
| 6 | 0.33 | −1.67 | 0.67 | | | | |
| 7 | 0.50 | −0.17 | 0.33 | | | | |
| 8 | 0.17 | 0.33 | 0.50 | | | | |
| 9 | 0.50 | −0.33 | −0.33 | | | | |
| 10 | 0.50 | 0.33 | 0.33 | | | | |
| 11 | −0.33 | −0.50 | 0.50 | | | | |
| 12 | 0.50 | −0.50 | 0.33 | | | | |

(b) Deviation and Covariance Matrix for subgroup 2

| | | | | | | | |
|---|---|---|---|---|---|---|---|
| 1 | 0.67 | 0.33 | −0.50 | P1 | 0.43 | 0.03 | 0.00 |
| 2 | 0.00 | −0.67 | −0.33 | P2 | 0.03 | 0.63 | 0.00 |
| 3 | −1.17 | 0.50 | 0.00 | P3 | 0.00 | 0.00 | 0.21 |
| 4 | 0.83 | −0.33 | 0.83 | | | | |
| 5 | 0.83 | 1.00 | 0.33 | | | | |
| 6 | −0.67 | 1.33 | 0.67 | | | | |
| 7 | 0.50 | 1.83 | 0.33 | | | | |
| 8 | 0.17 | 1.33 | −0.50 | | | | |
| 9 | −0.50 | 0.67 | −0.33 | | | | |
| 10 | −0.50 | −0.67 | 0.33 | | | | |
| 11 | −0.33 | 0.50 | 0.50 | | | | |
| 12 | −0.50 | 0.50 | 0.33 | | | | |

(c) Deviation and Covariance Matrix for subgroup 3

| | | | | | | | |
|---|---|---|---|---|---|---|---|
| 1 | −0.33 | 0.33 | −0.50 | P1 | 0.29 | 0.10 | −0.11 |
| 2 | −1.00 | 0.33 | −0.33 | P2 | 0.10 | 0.19 | −0.01 |
| 3 | 0.83 | 0.50 | −1.00 | P3 | 0.11 | −0.01 | 0.28 |
| 4 | −0.17 | −0.33 | −0.17 | | | | |
| 5 | −0.17 | 0.00 | 0.33 | | | | |
| 6 | 0.33 | 0.33 | −0.33 | | | | |
| 7 | −0.50 | −0.17 | 0.33 | | | | |
| 8 | 0.17 | 0.33 | 0.50 | | | | |
| 9 | −0.50 | 0.67 | 0.67 | | | | |
| 10 | −0.50 | −0.67 | −0.67 | | | | |
| 11 | 0.67 | 0.50 | −0.50 | | | | |
| 12 | −0.50 | −0.50 | 0.33 | | | | |

(d) Deviation and Covariance Matrix for subgroup 4

| | | | | | | | |
|---|---|---|---|---|---|---|---|
| 1 | −0.33 | 0.33 | 0.50 | P1 | 0.25 | 0.07 | 0.06 |
| 2 | 0.00 | 0.33 | 0.67 | P2 | 0.07 | 0.53 | −0.11 |
| 3 | −0.17 | −0.50 | 1.00 | P3 | 0.06 | −0.11 | 0.19 |
| 4 | −1.17 | 0.67 | −0.17 | | | | |
| 5 | −0.17 | 0.00 | 0.33 | | | | |
| 6 | 0.33 | 2.33 | −0.33 | | | | |
| 7 | −0.50 | 0.83 | 0.33 | | | | |
| 8 | 0.17 | 0.33 | 0.50 | | | | |
| 9 | 0.50 | 0.67 | 0.67 | | | | |
| 10 | 0.50 | 0.33 | 0.33 | | | | |
| 11 | −0.33 | −0.50 | −0.50 | | | | |
| 12 | 0.50 | 0.50 | 0.33 | | | | |

(e) Deviation and Covariance Matrix for subgroup 5

| | | | | | | | |
|---|---|---|---|---|---|---|---|
| 1 | 0.67 | −0.67 | −0.50 | P1 | 0.39 | 0.09 | 0.03 |
| 2 | 1.00 | 0.33 | −0.33 | P2 | 0.09 | 0.34 | 0.06 |
| 3 | 0.83 | −0.50 | −1.00 | P3 | 0.03 | 0.06 | 0.14 |
| 4 | −0.17 | −0.33 | −0.17 | | | | |
| 5 | −0.17 | 0.00 | −0.67 | | | | |
| 6 | 0.33 | −1.67 | −0.33 | | | | |
| 7 | −0.50 | −0.17 | −0.67 | | | | |
| 8 | −0.83 | −0.67 | −0.50 | | | | |
| 9 | −0.50 | −0.33 | −0.33 | | | | |
| 10 | 0.50 | 0.33 | −0.67 | | | | |
| 11 | 0.67 | 0.50 | 0.50 | | | | |
| 12 | −0.50 | −0.50 | −0.67 | | | | |

(f) Deviation and Covariance Matrix for subgroup 6

| | | | | | | | |
|---|---|---|---|---|---|---|---|
| 1 | −0.33 | 0.33 | 0.50 | P1 | 0.41 | −0.22 | −0.17 |
| 2 | −1.00 | −0.67 | 0.67 | P2 | −0.22 | 0.77 | 0.19 |
| 3 | −1.17 | 0.50 | 0.00 | P3 | −0.17 | 0.19 | 0.22 |
| 4 | 0.83 | −0.33 | −0.17 | | | | |
| 5 | −0.17 | −1.00 | −0.67 | | | | |
| 6 | −0.67 | −0.67 | −0.33 | | | | |
| 7 | 0.50 | −2.17 | −0.67 | | | | |
| 8 | 0.17 | −1.67 | −0.50 | | | | |
| 9 | 0.50 | −1.33 | −0.33 | | | | |
| 10 | −0.50 | 0.33 | 0.33 | | | | |
| 11 | −0.33 | −0.50 | −0.50 | | | | |
| 12 | 0.50 | 0.50 | −0.67 | | | | |

In a third step, an average of six covariance matrixes is calculated, and an inverse matrix for the average is generated. In addition, standard deviations of the parameters P1, P2, and P3 are calculated. The result is shown in Table 4.

TABLE 4

| | | |
|---|---|---|
| P1 | P2 | P3 |

(a) Covariance Matrix Average

| | | | |
|---|---|---|---|
| P1 | 0.33 | 0.01 | −0.03 |
| P2 | 0.01 | 0.48 | 0.00 |
| P3 | −0.03 | 0.00 | 0.20 |

(b) Covariance Inverse Matrix

| | | | |
|---|---|---|---|
| P1 | 3.10 | −0.09 | 0.54 |
| P2 | −0.09 | 2.11 | −0.02 |
| P3 | 0.54 | −0.02 | 5.09 |

(c) Standard Deviation

| P1 | P2 | P3 |
|---|---|---|
| 0.57 | 0.78 | 0.51 |

In a fourth step, Hotelling's T-square values are calculated for the time series data in Table 1 using the deviances acquired in the second step and the covariance inverse matrix acquired in the third step, and upper control limits (UCL) are calculated. As a reference, the T-square value and the UCL can be calculated by using Equation 1.

T²=(X−μ)′Σ⁻¹(X−μ)

UCL=(kmp−kp−mp+p)/(km−k−p+1)*F(α;p,(km−k−p+1)) [Equation 1]

In other words, the Hotelling's T-square value is calculated by sequential multiplications by a deviation, a covariance inverse matrix, and a transpose of deviations. In addition, the UCL can be calculated by using an F distribution function. The UCL is determined by the number of data m (12 in the example), a tolerance α(0.001 is applied in the example), the number of parameters p (3 in the example), and the number of subgroups k (6 in the example). When m>20, an equation UCL=χ²_{α,p} or UCL=T²+3S_{T}² may be used. As an example, the Hotelling's T-square values and UCLs for the subgroup 1 are shown in Table 5.

TABLE 5

| | | | |
|---|---|---|---|
| m | P1 | P2 | P3 |

(a) Subgroup 1

| | | | |
|---|---|---|---|
| 1 | 1 | 1 | 4 |
| 2 | 1 | 0 | 6 |
| 3 | 15 | 1 | 5 |
| 4 | 13 | 0 | 6 |
| 5 | 12 | 2 | 5 |
| 6 | 11 | 25 | 15 |
| 7 | 11 | 38 | 16 |
| 8 | 11 | 35 | 15 |
| 9 | 11 | 34 | 6 |
| 10 | 11 | 33 | 5 |
| 11 | 12 | 34 | 5 |
| 12 | 11 | 34 | 5 |

(b) Deviation of Subgroup 1

| | | | |
|---|---|---|---|
| 1 | −0.33 | −0.67 | 0.50 |
| 2 | 1.00 | 0.33 | −0.33 |
| 3 | 0.89 | −0.50 | 1.00 |
| 4 | −0.17 | 0.67 | −0.17 |
| 5 | −0.17 | 0.00 | 0.33 |
| 6 | 0.33 | −1.67 | 0.67 |
| 7 | 0.50 | −0.17 | 0.33 |
| 8 | 0.17 | 0.33 | 0.50 |
| 9 | 0.50 | −0.33 | −0.33 |
| 10 | 0.50 | 0.33 | 0.33 |
| 11 | −0.33 | −0.50 | 0.50 |
| 12 | 0.50 | −0.50 | 0.33 |

(c) T-square and UCL

| m | T-SQARE | UCL |
|---|---|---|
| 1 | 2.35 | 15.78 |
| 2 | 3.48 | 15.78 |
| 3 | 8.76 | 15.78 |
| 4 | 1.22 | 15.78 |
| 5 | 0.59 | 15.78 |
| 6 | 8.83 | 15.78 |
| 7 | 1.60 | 15.78 |
| 8 | 1.67 | 15.78 |
| 9 | 1.42 | 15.78 |
| 10 | 1.72 | 15.78 |
| 11 | 1.94 | 15.78 |
| 12 | 2.10 | 15.78 |

The Hotelling's T-square values for subgroups 2 to 6 can be acquired by using the same method as shown in Table 6.

TABLE 6

| m | Subgroup 1 | Subgroup 2 | Subgroup 3 | Subgroup 4 | Subgroup 5 | Subgroup 6 | UCL |
|---|---|---|---|---|---|---|---|
| 1 | 2.35 | 2.49 | 2.06 | 1.68 | 3.29 | 1.68 | 15.78 |
| 2 | 3.48 | 1.49 | 4.32 | 2.49 | 3.48 | 5.47 | 15.78 |
| 3 | 8.76 | 4.85 | 6.81 | 5.52 | 6.92 | 4.85 | 15.78 |
| 4 | 1.22 | 6.73 | 0.48 | 5.65 | 0.48 | 2.42 | 15.78 |
| 5 | 0.59 | 4.96 | 0.59 | 0.59 | 2.47 | 4.52 | 15.78 |
| 6 | 8.83 | 7.02 | 1.01 | 12.14 | 6.71 | 3.30 | 15.78 |
| 7 | 1.60 | 8.41 | 1.21 | 2.68 | 3.44 | 12.69 | 15.78 |
| 8 | 1.67 | 5.00 | 1.67 | 1.67 | 4.70 | 7.13 | 15.78 |
| 9 | 1.42 | 2.52 | 3.65 | 4.25 | 1.72 | 5.00 | 15.78 |
| 10 | 1.72 | 2.05 | 4.25 | 1.72 | 2.89 | 1.42 | 15.78 |
| 11 | 1.94 | 1.98 | 2.77 | 2.28 | 3.47 | 2.28 | 15.78 |
| 12 | 2.10 | 1.72 | 1.65 | 2.00 | 3.86 | 3.17 | 15.78 |

As a result, since the acquired T-square values do not exceed UCLs, respectively, the T-square values are determined to be applied as reference data. Up to now, only a variation for each step, that is, a variation of a short term component is described. Now, a method of checking average variations for several steps, that is, a variation of a long term component will be described. In the above example, a method of checking an average variation for each subgroup is to calculate averages for each subgroup and a total average, to calculate deviations for each subgroup, and to calculate the Hotelling's T-square values using the covariance inverse matrixes which have been calculated before. The T-square values can be acquired by using Equation 2 with m=12, and the result is shown in Table 7.

T²=m*(X−μ)′Σ−1(X−μ) [Equation 2]

TABLE 7
(a) Averages of Subgroups

| Subgroup | P1 | P2 | P3 |
|---|---|---|---|
| Subgroup 1 | 10.00 | 19.75 | 7.75 |
| Subgroup 2 | 10.33 | 19.00 | 7.92 |
| Subgroup 3 | 10.42 | 19.42 | 8.17 |
| Subgroup 4 | 10.33 | 19.08 | 7.75 |
| Subgroup 5 | 10.17 | 19.98 | 8.50 |
| Subgroup 6 | 10.42 | 20.08 | 8.25 |
| Average | 10.28 | 19.53 | 8.06 |

(b) Deviation and T-square values for total average

| Subgroup | P1 | P2 | P3 | T-SQARE | UCL |
|---|---|---|---|---|---|
| Subgroup 1 | 0.28 | −0.22 | 0.31 | 11.08 | 15.78 |
| Subgroup 2 | −0.06 | 0.53 | 0.14 | 8.26 | 15.78 |
| Subgroup 3 | −0.14 | 0.11 | −0.11 | 2.02 | 15.78 |
| Subgroup 4 | −0.06 | 0.44 | 0.31 | 10.57 | 15.78 |
| Subgroup 5 | 0.11 | −0.31 | −0.44 | 14.24 | 15.78 |
| Subgroup 6 | −0.14 | −0.56 | −0.19 | 10.96 | 15.78 |

Combining the results of the example up to now, variations for each subgroup and each step are represented by double T-square charts of the short term component and the long term component. All the checking results does not get off the UCLs, it can be determined that the parameters can be used as references.

In a fifth step, it is checked whether there is a variation in actual data compared with the references described above. When the actual data is as shown in FIG. 8, the method of checking variations in the parameters is as follows.

TABLE 8

| m | P1 | P2 | P3 |
|---|---|---|---|
| 1 | 1 | 0 | 5 |
| 2 | 2 | 1 | 6 |
| 3 | 15 | 0 | 7 |
| 4 | 12 | 1 | 6 |
| 5 | 11 | 2 | 6 |
| 6 | 12 | 28 | 15 |
| 7 | 11 | 42 | 16 |
| 8 | 12 | 36 | 15 |
| 9 | 11 | 33 | 6 |
| 10 | 12 | 33 | 5 |
| 11 | 12 | 34 | 7 |
| 12 | 15 | 33 | 5 |

At first, deviations from Table 8 are calculated by using the step averages which are shown in Table 2, and the Hotelling's T-square values and UCLs are acquired using the covariance inverse matrix shown in Table 4. The UCL for new data of which a variation is evaluated can be calculated by using Equation 3.

UCL=p(k+1)(m−1)/(km−k−p+1)*F(α;p,(km−k−p+1) [Equation 3]

Here, when m>20, an equation UCL=X²_{a,p} or UCL=T²+3S_{T}² may be used. As a result, the Hotelling's T-square values and the UCLs are shown in Table 9.

TABLE 9
(a) Deviations for actual data

| m | P1 | P2 | P3 |
|---|---|---|---|
| 1 | −0.33 | 0.33 | −0.50 |
| 2 | 0.00 | −0.67 | −0.33 |
| 3 | 0.83 | 0.50 | −1.00 |
| 4 | 0.83 | −0.33 | −0.17 |
| 5 | 0.83 | 0.00 | −0.67 |
| 6 | −0.67 | −4.67 | 0.67 |
| 7 | 0.50 | −4.17 | 0.33 |
| 8 | −0.83 | −0.67 | 0.50 |
| 9 | 0.50 | 0.67 | −0.33 |
| 10 | −0.50 | 0.33 | 0.33 |
| 11 | −0.33 | −0.50 | −1.50 |
| 12 | −3.50 | 0.50 | 0.33 |

(b) Hotelling's T-square and UCL

| m | T-SQARE | UCL |
|---|---|---|
| 1 | 2.06 | 22.09 |
| 2 | 1.49 | 22.09 |
| 3 | 6.81 | 22.09 |
| 4 | 2.42 | 22.09 |
| 5 | 3.81 | 22.09 |
| 6 | 48.58 | 22.09 |
| 7 | 38.49 | 22.09 |
| 8 | 3.82 | 22.09 |
| 9 | 2.05 | 22.09 |
| 10 | 1.42 | 22.09 |
| 11 | 12.80 | 22.09 |
| 12 | 38.10 | 22.09 |

As shown in Table 9, since the actual data gets off the UCLs in steps 6, 7, and 12, faults are detected. As described above, variations in multivariate can be detected.

A final step 6 relates to a method of checking a variation component. The Hotelling's T-square value represents a status of equipment as one value regardless of the number of parameters, and even delicate variations in the parameters are reflected well to be represented as a value of T-square, so that variation of equipment can be easily acquired. In addition, by which parameter the variation in the equipment is caused can be easily acquired through a decomposition process of the T-square, so that recently the Hotelling's T-square is used efficiently as a method of a multivariate analysis. An MYT decomposition method will now be described. The T-square can be divided into unconditional terms and conditional terms. The T-Square for three parameters in the aforementioned example can be divided as Equation 4.

T²=T²₁+T²_{2.1}+T²_{3.1,2} [Equation 4]

Here, T²₁ is an unconditional term, and T²_{2.1} and T²_{3.1,2} are conditional terms.

The unconditional term is calculated by dividing a square of a deviation by a square of a standard deviation. A value of the conditional term changes according to a degree of effects between the parameters. A general expression is shown in Equation 5.

Tₙ=(Xᵢₙ−Xₙ)²/s²ₙ

T_{p.1, 2 . . . , p-1}=(Xᵢₚ−X_{p.1, 2 . . . , p-1})/S_{p.1, 2 . . . , p-1}

Here,

X_{p.1, 2 . . . , p-1}=Xₚ+b′ₚ(Xᵢ^{(p-1)}−X^{(p-1)}),

bp=S_{XX}⁻¹s_{xX}, s²_{p.1, 2 . . . , p-1}=s²ₓ−s′_{xX}S⁻¹_{XX}s_{xX}

S_{XX}s_{xX}

s′_{xX}s²ₓ [Equation 5]

Unconditional term: UCL=(m+1)/m*F(1,m−1)

Conditional term: UCL=(m+1)(m−1)/(m*(m−k−1))*F(1,m−k−1) [Equation 6]

Here, m denotes the number of samples, and k denotes the number of conditioned variables. Accordingly, all the unconditional and conditional terms can be calculated as shown Table 10.

TABLE 10

| m | T²₁ | T²₂ | T²₃ | T²_{2.1} | T²_{1.2} | T²_{3.1} | T²_{1.3} | T²_{3.2} | T²_{2.3} | T²_{3.1,2} | T²_{2.1,3} | T²_{1.2,3} |
|---|---|---|---|---|---|---|---|---|---|---|---|---|
| 1 | 0.34 | 0.18 | 0.95 | 0.25 | 0.36 | 1.46 | 0.55 | 1.25 | 0.24 | 1.47 | 0.26 | 0.57 |
| 2 | 0.00 | 0.74 | 0.42 | 0.94 | 0.00 | 0.57 | 0.01 | 0.55 | 0.93 | 0.56 | 0.93 | 0.00 |
| 3 | 2.11 | 0.42 | 3.80 | 0.46 | 2.04 | 4.23 | 1.34 | 5.00 | 0.53 | 4.24 | 0.47 | 1.29 |
| 4 | 2.11 | 0.18 | 0.11 | 0.28 | 2.16 | 0.03 | 2.00 | 0.14 | 0.23 | 0.03 | 0.28 | 2.05 |
| 5 | 2.11 | 0.00 | 1.69 | 0.00 | 2.11 | 1.70 | 1.59 | 2.22 | 0.00 | 1.70 | 0.00 | 1.59 |
| 6 | 1.35 | 36.24 | 1.69 | 45.31 | 0.87 | 1.81 | 0.94 | 2.25 | 45.82 | 1.92 | 45.42 | 0.54 |
| 7 | 0.76 | 28.89 | 0.42 | 36.91 | 1.16 | 0.76 | 0.96 | 0.57 | 36.52 | 0.82 | 36.97 | 1.42 |
| 8 | 2.11 | 0.74 | 0.95 | 0.84 | 2.02 | 0.86 | 1.72 | 1.25 | 0.94 | 0.87 | 0.85 | 1.64 |
| 9 | 0.76 | 0.74 | 0.42 | 0.88 | 0.70 | 0.40 | 0.60 | 0.56 | 0.94 | 0.41 | 0.89 | 0.55 |
| 10 | 0.76 | 0.18 | 0.42 | 0.26 | 0.79 | 0.40 | 0.60 | 0.55 | 0.23 | 0.40 | 0.26 | 0.63 |
| 11 | 0.34 | 0.42 | 8.56 | 0.50 | 0.31 | 11.99 | 1.10 | 1.22 | 0.52 | 11.96 | 0.47 | 1.05 |
| 12 | 37.28 | 0.42 | 0.42 | 0.87 | 37.57 | 0.01 | 36.67 | 0.55 | 0.52 | 0.01 | 0.87 | 37.02 |
| UCL | 21.33 | 21.33 | 21.33 | 25.07 | 25.07 | 25.07 | 25.07 | 25.07 | 25.07 | 30.26 | 30.26 | 30.26 |

Combining the results up to now, it is detected that the actual data in Table 8 has a large variation of the parameter with respect to the reference for the steps 6, 7, and 12, as shown in FIG. 2. In addition, T²_{2.3}, T²_{2.1,3}, T²_{2.1} and T²₂ are determined to be major components for the variation in the step 6, as shown in FIG. 2, when the major components for the variation are analyzed. When the unconditional term has a larger value, it means that the parameter gets off the tolerance which is defined in the reference. On the other hand, when the conditional terms have a larger value, it means that counter correlation among the parameters occurs. Major components for the variation can be acquired by performing decomposition for all the steps using the same method, however, it is a general method that the equipment is checked with reference to decomposed components of steps among processing steps which have large T-square values.

The reference data which has been used in the aforementioned example for describing general technology seems to respond properly to detection and classification of a variation when the variation for each step is small. However, when the variation for each step is large, the reference data is useless. As an example, it is assumed that time series data as shown in Table 11 is used as reference data, and that there are over twenty subgroups, although for the convenience of description in the aforementioned example, there are only six subgroups, and descriptions will be followed.

TABLE 11

| | | | |
|---|---|---|---|
| m | P1 | P2 | P3 |

(a) Subgroup 1

| | | | |
|---|---|---|---|
| 1 | 5029 | 5 | 6 |
| 2 | 11050 | 6 | 5 |
| 3 | 7372 | 7 | 6 |
| 4 | 7885 | 9 | 6 |
| 5 | 7972 | 9 | 5 |
| 6 | 7772 | 9 | 589 |
| 7 | 8097 | 9 | 560 |
| 8 | 8053 | 10 | 553 |
| 9 | 8034 | 10 | 548 |
| 10 | 8028 | 11 | 549 |
| 11 | 8003 | 11 | 547 |
| 12 | 7997 | 11 | 545 |

(b) Subgroup 2

| | | | |
|---|---|---|---|
| 1 | 4329 | 4 | 5 |
| 2 | 10890 | 5 | 6 |
| 3 | 8291 | 7 | 5 |
| 4 | 7747 | 8 | 5 |
| 5 | 7953 | 9 | 5 |
| 6 | 7310 | 8 | 615 |
| 7 | 8128 | 9 | 559 |
| 8 | 8072 | 10 | 549 |
| 9 | 8028 | 10 | 544 |
| 10 | 8016 | 10 | 542 |
| 11 | 8016 | 11 | 541 |
| 12 | 8003 | 11 | 540 |

(c) Subgroup 3

| | | | |
|---|---|---|---|
| 1 | 5248 | 5 | 5 |
| 2 | 12010 | 6 | 6 |
| 3 | 6560 | 8 | 6 |
| 4 | 7703 | 8 | 5 |
| 5 | 7947 | 9 | 95 |
| 6 | 7947 | 8 | 561 |
| 7 | 7935 | 9 | 579 |
| 8 | 8097 | 10 | 555 |
| 9 | 8053 | 10 | 545 |
| 10 | 8022 | 10 | 543 |
| 11 | 8016 | 11 | 541 |
| 12 | 8003 | 11 | 540 |

(d) Subgroup 4

| | | | |
|---|---|---|---|
| 1 | 5092 | 5 | 5 |
| 2 | 10940 | 6 | 5 |
| 3 | 7478 | 7 | 5 |
| 4 | 7885 | 8 | 5 |
| 5 | 7966 | 8 | 111 |
| 6 | 8047 | 9 | 571 |
| 7 | 8091 | 9 | 554 |
| 8 | 8059 | 10 | 546 |
| 9 | 8022 | 11 | 542 |
| 10 | 8009 | 11 | 543 |
| 11 | 8009 | 11 | 541 |
| 12 | 7997 | 11 | 538 |

(e) Subgroup 5

| | | | |
|---|---|---|---|
| 1 | 4531 | 5 | 5 |
| 2 | 10500 | 6 | 5 |
| 3 | 7985 | 7 | 5 |
| 4 | 7747 | 8 | 5 |
| 5 | 7953 | 9 | 5 |
| 6 | 7235 | 8 | 600 |
| 7 | 8122 | 10 | 558 |
| 8 | 8072 | 10 | 547 |
| 9 | 8028 | 10 | 543 |
| 10 | 8009 | 10 | 542 |
| 11 | 8003 | 10 | 541 |
| 12 | 7997 | 11 | 538 |

(f) Subgroup 6

| | | | |
|---|---|---|---|
| 1 | 5716 | 5 | 5 |
| 2 | 10830 | 6 | 5 |
| 3 | 7497 | 7 | 5 |
| 4 | 7910 | 8 | 5 |
| 5 | 7841 | 9 | 105 |
| 6 | 8084 | 9 | 566 |
| 7 | 8078 | 9 | 551 |
| 8 | 8041 | 9 | 543 |
| 9 | 8016 | 10 | 542 |
| 10 | 8009 | 11 | 540 |
| 11 | 8003 | 11 | 538 |
| 12 | 7991 | 12 | 536 |

A result from modeling the time series data using general technology is shown in Table 12.

TABLE 12
(a) T-square for each step

| m | SG1 | SG2 | SG3 | SG4 | SG5 | SG6 | UCL |
|---|---|---|---|---|---|---|---|
| 1 | 0.23 | 10.76 | 1.09 | 0.33 | 3.15 | 7.44 | 16.27 |
| 2 | 0.19 | 5.02 | 13.35 | 0.32 | 4.22 | 0.79 | 16.27 |
| 3 | 0.52 | 8.22 | 18.03 | 0.23 | 3.07 | 0.21 | 16.27 |
| 4 | 4.91 | 0.25 | 0.36 | 0.27 | 0.25 | 0.33 | 16.27 |
| 5 | 9.51 | 9.58 | 7.50 | 14.86 | 9.58 | 11.08 | 16.27 |
| 6 | 2.06 | 6.02 | 4.90 | 2.96 | 4.97 | 3.56 | 16.27 |
| 7 | 0.20 | 0.25 | 1.48 | 0.42 | 4.71 | 0.64 | 16.27 |
| 8 | 0.31 | 0.19 | 0.45 | 0.19 | 0.18 | 5.29 | 16.27 |
| 9 | 0.21 | 0.19 | 0.19 | 4.70 | 0.21 | 0.24 | 16.27 |
| 10 | 2.08 | 1.77 | 1.73 | 1.72 | 1.77 | 1.66 | 16.27 |
| 11 | 0.38 | 0.19 | 0.19 | 0.19 | 4.83 | 0.20 | 16.27 |
| 12 | 0.25 | 0.19 | 0.19 | 0.22 | 0.22 | 4.65 | 16.27 |

(b) T-square for each average for subgroups

| Subgroup | T-SQARE |
|---|---|
| SG1 | 1.00 |
| SG2 | 15.35 |
| SG3 | 2.49 |
| SG4 | 2.02 |
| SG5 | 3.28 |
| SG6 | 6.24 |

In the example above, averages and deviations of the reference data are shown in Table 13. Actual data is assumed to be as shown in Table 14A. For the convenience of description, all actual data having a same value as an average of the reference data except for the parameter P3 in steps 1, 11, and 12 is input.

TABLE 13

| | | | |
|---|---|---|---|
| m | P1 | P2 | P3 |

(a) Average values of reference data

| | | | |
|---|---|---|---|
| 1 | 4990.83 | 4.83 | 5.17 |
| 2 | 11036.67 | 5.83 | 5.33 |
| 3 | 7530.50 | 7.17 | 5.33 |
| 4 | 7812.83 | 8.17 | 5.17 |
| 5 | 7938.67 | 8.83 | 54.33 |
| 6 | 7732.50 | 8.50 | 583.67 |
| 7 | 8075.17 | 9.17 | 560.17 |
| 8 | 8065.67 | 9.83 | 548.83 |
| 9 | 8030.17 | 10.17 | 544.00 |
| 10 | 8015.50 | 10.50 | 543.17 |
| 11 | 8008.33 | 10.83 | 541.50 |
| 12 | 7998.00 | 11.17 | 539.50 |

(b) Deviations of reference data

| | | | |
|---|---|---|---|
| 1 | 500.63 | 0.41 | 0.41 |
| 2 | 511.69 | 0.41 | 0.52 |
| 3 | 529.59 | 0.41 | 0.52 |
| 4 | 90.10 | 0.41 | 0.41 |
| 5 | 48.74 | 0.41 | 54.28 |
| 6 | 373.11 | 0.55 | 21.28 |
| 7 | 71.23 | 0.41 | 9.83 |
| 8 | 19.37 | 0.41 | 4.49 |
| 9 | 12.75 | 0.41 | 2.28 |
| 10 | 8.07 | 0.55 | 3.06 |
| 11 | 6.38 | 0.41 | 2.95 |
| 12 | 4.52 | 0.41 | 3.08 |

Accordingly, the Hotelling's T-square and the UCL for the actual data are calculated as shown in Table 14B.

TABLE 14
(a) Actual data

| m | P1 | P2 | P3 |
|---|---|---|---|
| 1 | 4990.83 | 4.83 | 50.00 |
| 2 | 11036.67 | 5.83 | 5.33 |
| 3 | 7530.50 | 7.17 | 5.33 |
| 4 | 7812.83 | 8.17 | 5.17 |
| 5 | 7938.67 | 8.83 | 54.33 |
| 6 | 7732.50 | 8.50 | 583.67 |
| 7 | 8075.17 | 9.17 | 560.17 |
| 8 | 8065.67 | 9.83 | 548.83 |
| 9 | 8030.17 | 10.17 | 544.00 |
| 10 | 8015.50 | 10.50 | 543.17 |
| 11 | 8008.33 | 10.83 | 560.00 |
| 12 | 7998.00 | 11.17 | 590.00 |

(b) T-square and UCL of actual data

| m | T-SQARE | UCL |
|---|---|---|
| 1 | 8.27 | 16.27 |
| 2 | 0.00 | 16.27 |
| 3 | 0.00 | 16.27 |
| 4 | 0.00 | 16.27 |
| 5 | 0.00 | 16.27 |
| 6 | 0.00 | 16.27 |
| 7 | 0.00 | 16.27 |
| 8 | 0.00 | 16.27 |
| 9 | 0.00 | 16.27 |
| 10 | 0.00 | 16.27 |
| 11 | 1.41 | 16.27 |
| 12 | 10.49 | 16.27 |

In Table 14, the T-square values for variation of the parameter P3 are not represented properly. In other words, the parameter P3 is data having an average of 5.17 and a standard deviation of 0.41 in the step 1, and so the value of the actual data having 50 is considerably out of a statistical range of the reference data, however, a T-square value, as illustrated in FIG. 3, does nor get out of the UCL, so that it is determined that the value of variation is not large. The basic reason for the aforementioned result is that a T-square value of actual data appears to be a relatively small as deviation (or standard deviation) of the reference data increases. Accordingly, when a covariance value of the total steps is calculated, the aforementioned problem cannot be solved. In addition, in Table 14, it is determined that the step 12 having a reference average of 539.50 and a standard deviation of 3.08 has the largest variation. Accordingly, a major component of the variance is firstly checked to monitor the equipment by mainly considering a result of decomposition for the step 12, so that the step 1 which generates larger variation is considered with a low priority.

### DISCLOSURE

### Technical Problem

The present invention provides a method of fault detection and classification in semiconductor manufacturing. In the method, delicate variations of actual data of parameters for which normal values of a manufacturing condition change according to time are detected very precisely and sensitively, and major variation components for a step which has a high occurrence occupancy are acquired to achieve a very precise and effective fault detection and classification (FDC).

### Technical Solution

According to an aspect of the present invention, there is provided a method of fault detection and classification in semiconductor manufacturing, the method comprising steps of: a first step for collecting reference data of all subgroups for each step of a process recipe; a second step for calculating averages, standard deviations, variances, covariance matrixes, and covariance inverse matrixes of the reference data; a third step for collecting the reference data by calculating Hotelling's T-square values and UCLs (upper control limit) of the reference data; a fourth step checking variations of newly observed data with respect to the reference data by calculating Hotelling's T-square values and UCLs of the newly observed data; and a fifth step for acquiring major components of variations for each step through a decomposition process.

In the aspect of the present invention, the variances and covariances may have non-zero values by adding or subtracting a small value that does not have a substantial effect on the original value to arbitrary one of the subgroups when a parameter has same values for all the subgroups.

In addition, values of the covariance inverse matrix may be set to zero to eliminate an effect of a parameter completely, when the parameter has same values for all the subgroups.

In addition, the calculating of Hotelling's T-square values in the third step may comprise removing reference data of which the T-square value is larger than the UCL and calculating an average, a standard deviation, a variance, a covariance matrix, a covariance inverse matrix of the reference data for each step to be used as the reference data.

In addition, the variations for each step in the fifth step may be detected by acquiring unconditional terms and conditional terms through a decomposition process.

### DESCRIPTION OF DRAWINGS

FIG. 1 is an exemplary diagram for describing a general modeling illustrating a short term component and a long term in one chart.

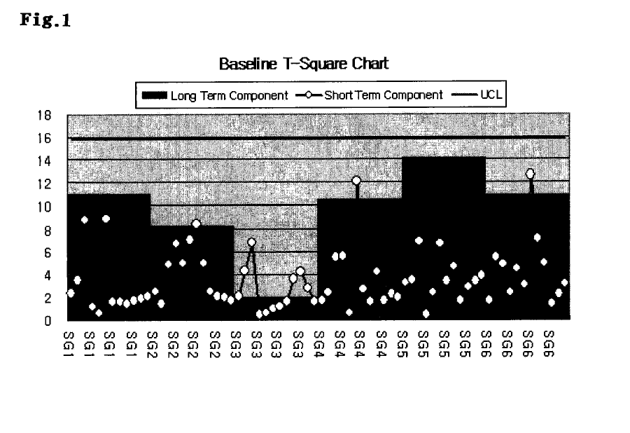

FIG. 2 is a resultant chart from detecting a fault of exemplary actual data according to general technology and illustrates a major component of a fault by decomposing a detected step 6.

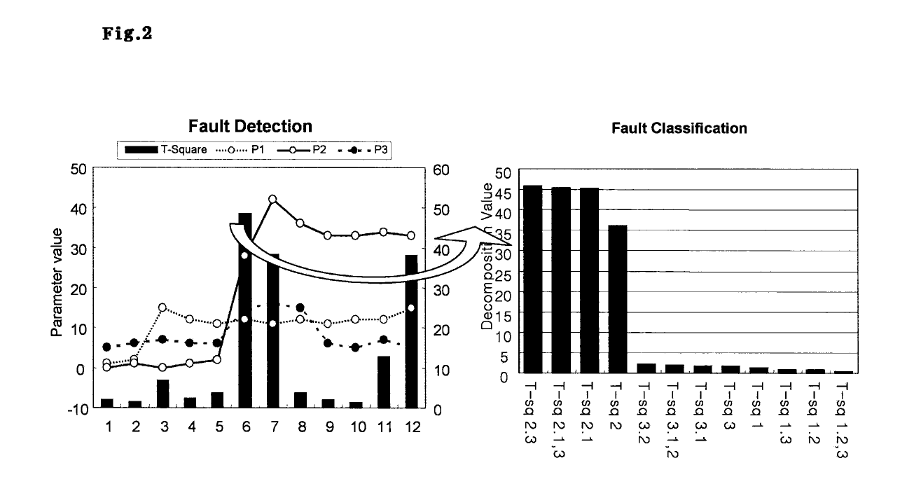

FIG. 3 is a chart illustrating a detected result of variations of actual data with respect to reference data which have large variations of a parameter according to general technology.

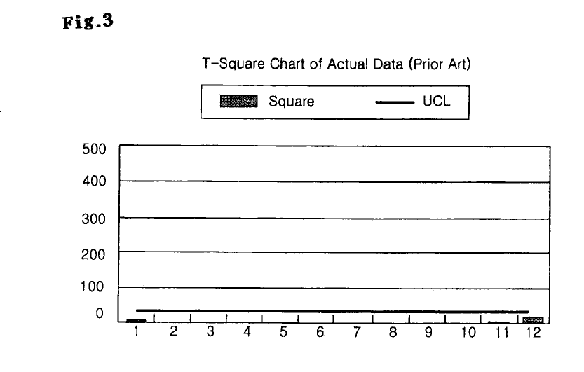

FIG. 4 is chart illustrating a detected result of variations of actual data with respect to reference data which have large variations of a parameter according to general technology and showing a major component of a fault by decomposing a fault of a step 1.

FIG. 5 is a chart illustrating fault detection according to an embodiment of the present invention and is for comparison with FIG. 3 which shows a detection result according to general technology.

### BEST MODE

The present invention will now be described more fully with reference to the accompanying drawings, in which exemplary embodiments of the invention are shown.

According to an embodiment of the present invention, a covariance and an inverse matrix are acquired for each step to be set as references by regarding continuous processes as separate processes which are not related to each other. In this case, variation or covariance acquired for each separated step has a value smaller than those for total steps to increase a Hotelling's T-square value for a small variation, so that a delicate variation can be sensitively detected.

A first step of an embodiment of the present invention for reference data is to collect the reference data of subgroups for each step of a process recipe and calculate an average, a standard deviation, a covariance matrix, and a covariance inverse matrix of the reference data for each step. The result is shown in Table 15.

TABLE 15

| | | |
|---|---|---|
| P1 | P2 | P3 |

Average and Standard Deviation

| | | | |
|---|---|---|---|
| SG1 | 5029 | 5 | 6 |
| SG2 | 4329 | 4 | 5 |
| SG3 | 5248 | 5 | 5 |
| SG4 | 5092 | 5 | 5 |
| SG5 | 4531 | 5 | 5 |
| SG6 | 5716 | 5 | 5 |
| average | 4990.83 | 4.83 | 5.17 |
| standard | 500.63 | 0.41 | 0.41 |
| deviation | | | |

Covariance Matrix

| | | | |
|---|---|---|---|
| P1 | 250632.57 | 132.37 | 7.63 |
| P2 | 132.37 | 0.17 | 0.03 |
| P3 | 7.63 | 0.03 | 0.17 |

Covariance Inverse Matrix

| | | | |
|---|---|---|---|
| P1 | 0.00 | −0.01 | 0.00 |
| P2 | −0.01 | 10.92 | −1.92 |
| P3 | 0.00 | −1.92 | 6.35 |

(a) Average, Standard Deviation, Covariance Matrix, and Covariance Inverse Matrix for m=1

| | | |
|---|---|---|
| P1 | P2 | P3 |

Average and Standard Deviation

| | | | |
|---|---|---|---|
| SG1 | 11050 | 6 | 5 |
| SG2 | 10890 | 5 | 6 |
| SG3 | 12010 | 6 | 6 |
| SG4 | 10940 | 6 | 5 |
| SG5 | 10500 | 6 | 5 |
| SG6 | 10830 | 6 | 5 |
| average | 11036.67 | 5.83 | 5.33 |
| standard | 511.69 | 0.41 | 0.52 |
| deviation | | | |

Covariance Matrix

| | | | |
|---|---|---|---|
| P1 | 261826.67 | 29.33 | 165.33 |
| P2 | 29.33 | 0.17 | −0.13 |
| P3 | 165.33 | −0.13 | 0.27 |

Covariance Inverse Matrix

| | | | |
|---|---|---|---|
| P1 | 0.00 | −0.03 | −0.03 |
| P2 | −0.03 | 47.02 | 44.01 |
| P3 | −0.03 | 44.01 | 47.35 |

(b) Average, Standard Deviation, Covariance Matrix, and Covariance Inverse Matrix for m=2

| | | |
|---|---|---|
| P1 | P2 | P3 |

Average and Standard Deviation

| | | | |
|---|---|---|---|
| SG1 | 7372 | 7 | 6 |
| SG2 | 8291 | 7 | 5 |
| SG3 | 6560 | 8 | 6 |
| SG4 | 7478 | 7 | 5 |
| SG5 | 7985 | 7 | 5 |
| SG6 | 7497 | 7 | 5 |
| average | 7530.50 | 7.17 | 5.33 |
| standard | 592.59 | 0.41 | 0.52 |
| deviation | | | |

Covariance Matrix

| | | | |
|---|---|---|---|
| P1 | 351160.30 | −194.10 | −225.80 |
| P2 | −194.10 | 0.17 | 0.13 |
| P3 | −225.80 | 0.13 | 0.27 |

Covariance Inverse Matrix

| | | | |
|---|---|---|---|
| P1 | 0.00 | 0.01 | 0.00 |
| P2 | 0.01 | 17.01 | −1.19 |
| P3 | 0.00 | −1.19 | 8.32 |

(c) Average, Standard Deviation, Covariance Matrix, and Covariance Inverse Matrix for m=3

| | | |
|---|---|---|
| P1 | P2 | P3 |

Average and Standard Deviation

| | | | |
|---|---|---|---|
| SG1 | 7885 | 9 | 6 |
| SG2 | 7747 | 8 | 5 |
| SG3 | 7703 | 8 | 5 |
| SG4 | 7885 | 8 | 5 |
| SG5 | 7747 | 8 | 5 |
| SG6 | 7910 | 8 | 5 |
| average | 7812.83 | 8.17 | 5.17 |
| standard | 90.10 | 0.41 | 0.41 |
| deviation | | | |

Covariance Matrix

| | | | |
|---|---|---|---|
| P1 | 8117.77 | 14.43 | 14.43 |
| P2 | 14.43 | 0.17 | 0.17 |
| P3 | 14.43 | 0.17 | 0.17 |

Covariance Inverse Matrix

| | | | |
|---|---|---|---|
| P1 | 0.00 | −0.01 | −0.01 |
| P2 | −0.01 | 7205759403792790.00 | −7205759403792790.00 |
| P3 | −0.01 | −7205759403792790.00 | 7205759403792790.00 |

(d) Average, Standard Deviation, Covariance Matrix, and Covariance Inverse Matrix for m=4

Average and Standard Deviation

| | P1 | P2 | P3 |
|---|---|---|---|
| SG1 | 7972 | 9 | 5 |
| SG2 | 7953 | 9 | 5 |
| SG3 | 7947 | 9 | 95 |
| SG4 | 7966 | 8 | 111 |
| SG5 | 7953 | 9 | 5 |
| SG6 | 7841 | 9 | 105 |
| average | 7938.67 | 8.83 | 54.33 |
| standard | 48.74 | 0.41 | 54.28 |
| deviation | | | |

Covariance Matrix

| | P1 | P2 | P3 |
|---|---|---|---|
| P1 | 2375.47 | −5.47 | −1223.87 |
| P2 | −5.47 | 0.17 | −11.33 |
| P3 | −1223.87 | −11.33 | 2946.67 |

Covariance Inverse Matrix

| | P1 | P2 | P3 |
|---|---|---|---|
| P1 | 0.00 | 0.08 | 0.00 |
| P2 | 0.08 | 14.78 | 0.09 |
| P3 | 0.00 | 0.09 | 0.00 |

(e) Average, Standard Deviation, Covariance Matrix, and Covariance Inverse Matrix for m=5

Average and Standard Deviation

| | P1 | P2 | P3 |
|---|---|---|---|
| SG1 | 7772 | 9 | 589 |
| SG2 | 7310 | 8 | 615 |
| SG3 | 7947 | 8 | 561 |
| SG4 | 8047 | 9 | 571 |
| SG5 | 7235 | 8 | 600 |
| SG6 | 8084 | 9 | 566 |
| average | 7732.50 | 8.50 | 583.67 |
| standard | 373.11 | 0.55 | 21.28 |
| deviation | | | |

Covariance Matrix

| | P1 | P2 | P3 |
|---|---|---|---|
| P1 | 139209.10 | 141.10 | −7241.80 |
| P2 | 141.10 | 0.30 | −5.00 |
| P3 | −7241.80 | −5.00 | 452.67 |

Covariance Inverse Matrix

| | P1 | P2 | P3 |
|---|---|---|---|
| P1 | 0.00 | −0.03 | 0.00 |
| P2 | −0.03 | 11.78 | −0.36 |
| P3 | 0.00 | −0.36 | 0.02 |

(f) Average, Standard Deviation, Covariance Matrix, and Covariance Inverse Matrix for m=6

(a) Averages of Subgroups

| Subgroup | P1 | P2 | P3 |
|---|---|---|---|
| Subgroup1 | 10.00 | 19.75 | 7.75 |
| Subgroup2 | 10.33 | 19.00 | 7.92 |
| Subgroup3 | 10.42 | 19.42 | 8.17 |
| Subgroup4 | 10.33 | 19.08 | 7.75 |
| Subgroup5 | 10.17 | 19.98 | 8.50 |
| Subgroup6 | 10.42 | 20.08 | 8.25 |
| Average | 10.28 | 19.53 | 8.06 |

(b) Deviation and T-square values for total average

| Subgroup | P1 | P2 | P3 | T-SQARE | UCL |
|---|---|---|---|---|---|
| Subgroup1 | 0.28 | −0.22 | 0.31 | 11.08 | 15.78 |
| Subgroup2 | −0.06 | 0.53 | 0.14 | 8.26 | 15.78 |
| Subgroup3 | −0.14 | 0.11 | −0.11 | 2.02 | 15.78 |
| Subgroup4 | −0.06 | 0.44 | 0.31 | 10.57 | 15.78 |
| Subgroup5 | 0.11 | −0.31 | −0.44 | 14.24 | 15.78 |
| Subgroup6 | −0.14 | −0.56 | −0.19 | 10.96 | 15.78 |

(g) Average, Standard Deviation, Covariance Matrix, and Covariance Inverse Matrix for m=7

Average and Standard Deviation

| | P1 | P2 | P3 |
|---|---|---|---|
| SG1 | 8053 | 10 | 553 |
| SG2 | 8072 | 10 | 549 |
| SG3 | 8097 | 10 | 555 |
| SG4 | 8059 | 10 | 546 |
| SG5 | 8072 | 10 | 547 |
| SG6 | 8041 | 9 | 543 |
| average | 8065.67 | 9.83 | 548.83 |
| standard | 19.37 | 0.41 | 4.49 |
| deviation | | | |

Covariance Matrix

| | P1 | P2 | P3 |
|---|---|---|---|
| P1 | 375.07 | 4.93 | 58.53 |
| P2 | 4.93 | 0.17 | 1.17 |
| P3 | 58.53 | 1.17 | 20.17 |

Covariance Inverse Matrix

| | P1 | P2 | P3 |
|---|---|---|---|
| P1 | 0.01 | −0.09 | −0.01 |
| P2 | −0.09 | 11.43 | −0.41 |
| P3 | −0.01 | −0.41 | 0.11 |

(h) Average, Standard Deviation, Covariance Matrix, and Covariance Inverse Matrix for m=8

Average and Standard Deviation

| | P1 | P2 | P3 |
|---|---|---|---|
| SG1 | 8034 | 10 | 548 |
| SG2 | 8028 | 10 | 544 |
| SG3 | 8053 | 10 | 545 |
| SG4 | 8022 | 11 | 542 |
| SG5 | 8028 | 10 | 543 |
| SG6 | 8016 | 10 | 542 |
| average | 8030.17 | 10.17 | 544.00 |
| standard | 12.75 | 0.41 | 2.28 |
| deviation | | | |

Covariance Matrix

| | P1 | P2 | P3 |
|---|---|---|---|
| P1 | 162.57 | −1.63 | 17.00 |
| P2 | −1.63 | 0.17 | −0.40 |
| P3 | 17.00 | −0.40 | 5.20 |

Covariance Inverse Matrix

| | P1 | P2 | P3 |
|---|---|---|---|
| P1 | 0.01 | 0.02 | −0.03 |
| P2 | 0.02 | 7.41 | 0.50 |
| P3 | −0.03 | 0.50 | 0.33 |

(i) Average, Standard Deviation, Covariance Matrix, and Covariance Inverse Matrix for m=9

Average and Standard Deviation

| | P1 | P2 | P3 |
|---|---|---|---|
| SG1 | 8028 | 11 | 549 |
| SG2 | 8016 | 10 | 542 |
| SG3 | 8022 | 10 | 543 |
| SG4 | 8009 | 11 | 543 |
| SG5 | 8009 | 10 | 542 |
| SG6 | 8009 | 11 | 540 |
| average | 8015.50 | 10.50 | 543.17 |
| standard | 8.07 | 0.55 | 3.06 |
| deviation | | | |

Covariance Matrix

| | P1 | P2 | P3 |
|---|---|---|---|
| P1 | 65.10 | −0.10 | 20.10 |
| P2 | −0.10 | 0.30 | 0.50 |
| P3 | 20.10 | 0.50 | 9.37 |

Covariance Inverse Matrix

| | P1 | P2 | P3 |
|---|---|---|---|
| P1 | 0.06 | 0.25 | −0.14 |
| P2 | 0.25 | 4.75 | −0.80 |
| P3 | −0.14 | −0.80 | 0.45 |

(j) Average, Standard Deviation, Covariance Matrix, and Covariance Inverse Matrix for m=10

Average and Standard Deviation

| | P1 | P2 | P3 |
|---|---|---|---|
| SG1 | 8003 | 11 | 547 |
| SG2 | 8016 | 11 | 541 |
| SG3 | 8016 | 11 | 541 |
| SG4 | 8009 | 11 | 541 |
| SG5 | 8003 | 10 | 541 |
| SG6 | 8003 | 11 | 538 |
| average | 8008.33 | 10.83 | 541.50 |
| standard | 6.38 | 0.41 | 2.95 |
| deviation | | | |

Covariance Matrix

| | P1 | P2 | P3 |
|---|---|---|---|
| P1 | 40.67 | 1.07 | −3.20 |
| P2 | 1.07 | 0.17 | 0.10 |
| P3 | −3.20 | 0.10 | 8.70 |

Covariance Inverse Matrix

| | P1 | P2 | P3 |
|---|---|---|---|
| P1 | 0.03 | −0.21 | 0.01 |
| P2 | −0.21 | 7.42 | −0.16 |
| P3 | 0.01 | −0.16 | 0.12 |

(k) Average, Standard Deviation, Covariance Matrix, and Covariance Inverse Matrix for m=11

(a) T-square for each step

| m | SG1 | SG2 | SG3 | SG4 | SG5 | SG6 | UCL |
|---|---|---|---|---|---|---|---|
| 1 | 0.23 | 10.76 | 1.09 | 0.33 | 3.15 | 7.44 | 16.27 |
| 2 | 0.19 | 5.02 | 13.35 | 0.32 | 4.22 | 0.79 | 16.27 |
| 3 | 0.52 | 8.22 | 18.03 | 0.23 | 3.07 | 0.21 | 16.27 |
| 4 | 4.91 | 0.25 | 0.36 | 0.27 | 0.25 | 0.33 | 16.27 |
| 5 | 9.51 | 9.58 | 7.50 | 14.86 | 9.58 | 11.08 | 16.27 |
| 6 | 2.06 | 6.02 | 4.90 | 2.96 | 4.97 | 3.56 | 16.27 |
| 7 | 0.20 | 0.25 | 1.48 | 0.42 | 4.71 | 0.64 | 16.27 |
| 8 | 0.31 | 0.19 | 0.45 | 0.19 | 0.18 | 5.29 | 16.27 |
| 9 | 0.21 | 0.19 | 0.19 | 4.70 | 0.21 | 0.24 | 16.27 |
| 10 | 2.08 | 1.77 | 1.73 | 1.72 | 1.77 | 1.66 | 16.27 |
| 11 | 0.38 | 0.19 | 0.19 | 0.19 | 4.83 | 0.20 | 16.27 |
| 12 | 0.25 | 0.19 | 0.19 | 0.22 | 0.22 | 4.65 | 16.27 |

(b) T-square for each average for subgroups

| Subgroup | T-SQARE |
|---|---|
| SG1 | 1.00 |
| SG2 | 15.35 |
| SG3 | 2.49 |
| SG4 | 2.02 |
| SG5 | 3.28 |
| SG6 | 6.24 |

(l) Average, Standard Deviation, Covariance Matrix, and Covariance Inverse Matrix for m=12

In Table 15, when a parameter has same values for all the subgroups, the covariance of the parameter becomes zero, so that a case where the covariance inverse matrix cannot be calculated, that is, incommutability occurs. In this case, values of the covariance inverse matrix may be set to zero to eliminate an effect of the parameter completely. Alternatively, arbitrary one value of the subgroups may be changed by adding or subtracting a small value that does not have a substantial effect on the original value, so that the covariance does not become zero.

In a second step, Hotelling's T-square values for the reference data are calculated. A result from calculating the T-square values for the subgroup 1 among the reference data is shown in Table 16. According to an embodiment of the present invention, averages, covariance values, and inverse matrixes are different for each step, unlike general technology.

TABLE 16

| m | P1 | P2 | P3 | m | P1 | P2 | P3 | m | T-SQARE |
|---|---|---|---|---|---|---|---|---|---|
| 1 | 5029 | 5 | 6 | 1 | −38.17 | −0.17 | −0.83 | 1 | 4.17 |
| 2 | 11050 | 6 | 5 | 2 | −13.33 | −0.17 | 0.33 | 2 | 1.85 |
| 3 | 7372 | 7 | 6 | 3 | 158.50 | 0.17 | −0.67 | 3 | 4.17 |
| 4 | 7885 | 9 | 6 | 4 | −72.17 | −0.83 | −0.83 | 4 | 5.00 |
| 5 | 7972 | 9 | 5 | 5 | −33.33 | −0.17 | 49.33 | 5 | 0.95 |
| 6 | 7772 | 9 | 589 | 6 | −39.50 | −0.50 | −5.33 | 6 | 1.37 |
| 7 | 8097 | 9 | 560 | 7 | −21.83 | 0.17 | 0.17 | 7 | 0.79 |
| 8 | 8053 | 10 | 553 | 8 | 12.67 | −0.17 | −4.17 | 8 | 3.99 |
| 9 | 8034 | 10 | 548 | 9 | −3.83 | 0.17 | −4.00 | 9 | 3.97 |
| 10 | 8028 | 11 | 549 | 10 | −12.50 | −0.50 | −5.83 | 10 | 3.80 |
| 11 | 8003 | 11 | 547 | 11 | 5.33 | −0.17 | −5.50 | 11 | 4.04 |
| 12 | 7997 | 11 | 545 | 12 | 1.00 | 0.17 | −5.50 | 12 | 4.17 |

By using the same method, the T-square values are calculated, and the UCL values are checked for each one of the subgroups 2 to 6 to check whether it is appropriate to be a reference. The result is shown in Table 17. After reference data for which the T-square value is larger than the UCL is removed, an average, a standard deviation, a variance, a covariance matrix, a covariance inverse matrix of the reference data of each step are calculated to be used as the reference data.

TABLE 17

| m | SG1 | SG2 | SG3 | SG4 | SG5 | SG6 | UCL |
|---|---|---|---|---|---|---|---|
| 1 | 4.17 | 4.17 | 0.49 | 0.44 | 3.06 | 2.68 | 16.27 |
| 2 | 1.85 | 4.17 | 4.17 | 0.77 | 3.63 | 0.42 | 16.27 |
| 3 | 4.17 | 2.85 | 4.17 | 1.61 | 0.73 | 1.48 | 16.27 |
| 4 | 5.00 | 0.53 | 1.48 | 1.28 | 0.53 | 2.00 | 16.27 |
| 5 | 0.95 | 0.89 | 4.04 | 4.17 | 0.89 | 4.06 | 16.27 |
| 6 | 1.37 | 3.96 | 3.63 | 0.94 | 4.03 | 1.08 | 16.27 |
| 7 | 0.79 | 2.44 | 4.12 | 0.77 | 4.17 | 2.71 | 16.27 |
| 8 | 3.99 | 0.31 | 3.74 | 1.57 | 1.22 | 4.17 | 16.27 |
| 9 | 3.97 | 0.27 | 3.78 | 4.17 | 0.63 | 2.19 | 16.27 |
| 10 | 3.80 | 0.92 | 2.22 | 1.88 | 2.88 | 3.30 | 16.27 |
| 11 | 4.04 | 1.46 | 1.46 | 0.22 | 4.17 | 3.66 | 16.27 |
| 12 | 4.17 | 1.67 | 1.67 | 1.67 | 1.67 | 4.17 | 16.27 |

In a third step, the Hotelling's T-square values of newly observed data are calculated for checking variations of actual data with respect to the reference data. The result is shown in Table 18.

TABLE 18
(a) Actual Data

| m | P1 | P2 | P3 |
|---|---|---|---|
| 1 | 4990.83 | 4.83 | 50.00 |
| 2 | 11036.67 | 5.83 | 5.33 |
| 3 | 7530.50 | 7.17 | 5.33 |
| 4 | 7812.83 | 8.17 | 5.17 |
| 5 | 7938.67 | 8.83 | 54.33 |
| 6 | 7732.50 | 8.50 | 583.67 |
| 7 | 8075.17 | 9.17 | 560.17 |
| 8 | 8065.67 | 9.83 | 548.83 |
| 9 | 8030.17 | 10.17 | 544.00 |
| 10 | 8015.50 | 10.50 | 543.17 |
| 11 | 8008.33 | 10.83 | 560.00 |
| 12 | 7998.00 | 11.17 | 590.00 |

(b) Hotelling's T-Square and UCL

| m | T-SQARE | UCL |
|---|---|---|
| 1 | 12757.17 | 16.27 |
| 2 | 0.00 | 16.27 |
| 3 | 0.00 | 16.27 |
| 4 | 0.00 | 16.27 |
| 5 | 0.00 | 16.27 |
| 6 | 0.00 | 16.27 |
| 7 | 0.00 | 16.27 |
| 8 | 0.00 | 16.27 |
| 9 | 0.00 | 16.27 |
| 10 | 0.00 | 16.27 |
| 11 | 41.72 | 16.27 |
| 12 | 390.34 | 16.27 |

Accordingly, when the T-square values are calculated using a method according to an embodiment of the present invention, the T-square values become large in steps 1, 11, and 12 due to variation of the parameter P3, thereby improving the sensitivity for change in an equipment status.

In a fourth step, unconditional terms and conditional terms are acquired through a decomposition process. The result is shown in Table 19.

TABLE 19

| m | T²₁ | T²₂ | T²₃ | T²_{2.1} | T²_{1.2} | T²_{3.1} | T²_{1.3} | T²_{3.2} | T²_{2.3} | T²_{3.1,2} | T²_{2.1,3} | T²_{1.2,3} |
|---|---|---|---|---|---|---|---|---|---|---|---|---|
| 1 | 0.0 | 0.0 | 12060.2 | 0.0 | 0.0 | 12077.0 | 16.8 | 12562.7 | 502.5 | 12757.2 | 680.2 | 194.5 |
| 2 | 0.0 | 0.0 | 0.0 | 0.0 | 0.0 | 0.0 | 0.0 | 0.0 | 0.0 | 0.0 | 0.0 | 0.0 |
| 3 | 0.0 | 0.0 | 0.0 | 0.0 | 0.0 | 0.0 | 0.0 | 0.0 | 0.0 | 0.0 | 0.0 | 0.0 |
| 4 | 0.0 | 0.0 | 0.0 | 0.0 | 0.0 | 0.0 | 0.0 | 0.0 | 0.0 | 0.0 | 0.0 | 0.0 |
| 5 | 0.0 | 0.0 | 0.0 | 0.0 | 0.0 | 0.0 | 0.0 | 0.0 | 0.0 | 0.0 | 0.0 | 0.0 |
| 6 | 0.0 | 0.0 | 0.0 | 0.0 | 0.0 | 0.0 | 0.0 | 0.0 | 0.0 | 0.0 | 0.0 | 0.0 |
| 7 | 0.0 | 0.0 | 0.0 | 0.0 | 0.0 | 0.0 | 0.0 | 0.0 | 0.0 | 0.0 | 0.0 | 0.0 |
| 8 | 0.0 | 0.0 | 0.0 | 0.0 | 0.0 | 0.0 | 0.0 | 0.0 | 0.0 | 0.0 | 0.0 | 0.0 |
| 9 | 0.0 | 0.0 | 0.0 | 0.0 | 0.0 | 0.0 | 0.0 | 0.0 | 0.0 | 0.0 | 0.0 | 0.0 |
| 10 | 0.0 | 0.0 | 0.0 | 0.0 | 0.0 | 0.0 | 0.0 | 0.0 | 0.0 | 0.0 | 0.0 | 0.0 |
| 11 | 0.0 | 0.0 | 39.3 | 0.0 | 0.0 | 40.5 | 1.2 | 39.6 | 0.3 | 41.7 | 1.2 | 2.1 |
| 12 | 0.0 | 0.0 | 268.4 | 0.0 | 0.0 | 316.0 | 47.5 | 388.8 | 120.3 | 390.3 | 74.4 | 1.6 |
| UCL | 39.3 | 39.3 | 39.3 | 11.2 | 11.2 | 11.2 | 11.2 | 11.2 | 11.2 | 19.7 | 19.7 | 19.7 |

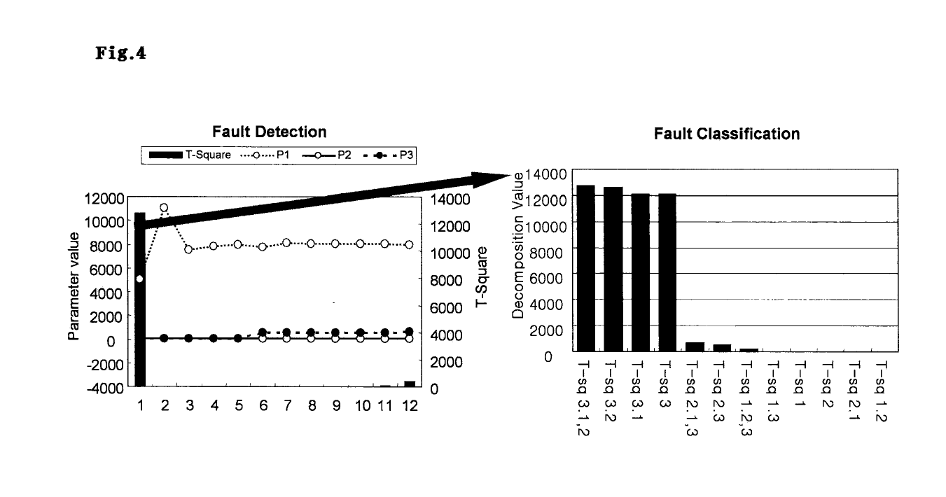

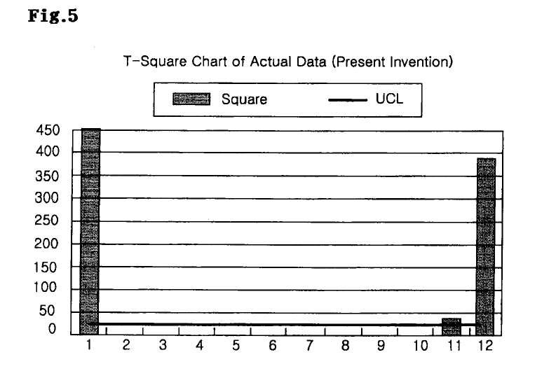

As a conclusion, when a method in which continuous steps in a process are regarded as separate processes not related to each other, and covariance matrixes and covariance inverse matrixes acquired for each step are set as references is used, as shown in FIG. 4, not only variation of an equipment can be detected sensitively, but also major variation components of a step which has the most problems actually can be precisely classified, thereby a basic function of fault detection and classification (FDC) can be precisely performed. FIG. 5 shows a result from decomposing the step 1 according to an embodiment of the present invention, and it is shown that T²_{3.1,2}, T²_{3.2}, T²_{3.1}, and T²₃ components are primary causes for the variation.

Up to now, a method in which the T-square values for each step are calculated and variations (short term component) for each step are detected and decomposed is described. However, the present invention can be applied to a case where average variations (long term component) of parameters for every two or three steps are detected to check major components of variations, so that a precise detection of variation and checking a major component can be performed. As an example, for detecting variations of the equipment for every two steps, averages of reference data for steps 1 to 12 are calculated, respectively, and covariance and an inverse matrix are calculated. The result is shown in Table 20. After the result is set to reference data, the Hotelling [symbol] T-square values of actual data are calculated to detect a variation or decomposition is performed for checking variation components.

TABLE 20
Average and Standard Deviation

| | P1 | P2 | P3 |
|---|---|---|---|
| SG1 | 8039.5 | 5.5 | 5.5 |
| SG2 | 7609.5 | 4.5 | 5.5 |
| SG3 | 8629.0 | 5.5 | 5.5 |
| SG4 | 8016.0 | 5.5 | 5.0 |
| SG5 | 7515.5 | 5.5 | 5.0 |
| SG6 | 8273.0 | 5.5 | 5.0 |
| average | 8013.75 | 5.33 | 5.25 |
| standard | 414.27 | 0.41 | 0.27 |
| deviation | | | |

Covariance Matrix

| | P1 | P2 | P3 |
|---|---|---|---|
| P1 | 171616.48 | 80.85 | 23.68 |
| P2 | 80.85 | 0.17 | −0.07 |
| P3 | 23.68 | −0.05 | 0.08 |

Covariance Inverse Matrix

| | P1 | P2 | P3 |
|---|---|---|---|
| P1 | 0.00 | −0.01 | −0.01 |
| P2 | −0.01 | 13.08 | 11.15 |
| P3 | −0.01 | 11.15 | 23.45 |

(a) Average, Standard Deviation, Covariance Matrix, and Covariance Inverse Matrix for m=1 to 2

Average and Standard Deviation

| | P1 | P2 | P3 |
|---|---|---|---|
| SG1 | 7628.5 | 8.0 | 6.0 |
| SG2 | 8019.0 | 7.5 | 5.0 |
| SG3 | 7131.5 | 8.0 | 5.5 |
| SG4 | 7681.5 | 7.5 | 5.0 |
| SG5 | 7866.0 | 7.5 | 5.0 |
| SG6 | 7703.5 | 7.5 | 5.0 |
| average | 7671.67 | 7.67 | 5.25 |
| standard | 301.05 | 0.26 | 0.42 |
| deviation | | | |

Covariance Matrix

| | P1 | P2 | P3 |
|---|---|---|---|
| P1 | 90631.87 | −58.33 | −62.65 |
| P2 | −58.33 | 0.07 | 0.10 |
| P3 | −62.65 | 0.10 | 0.18 |

Covariance Inverse Matrix

| | P1 | P2 | P3 |
|---|---|---|---|
| P1 | 0.00 | 0.16 | −0.07 |
| P2 | 0.16 | 480.97 | −217.95 |
| P3 | −0.07 | −217.95 | 106.36 |

(b) Average, Standard Deviation, Covariance Matrix, and Covariance Inverse Matrix for m=3 to 4

Average and Standard Deviation

| | P1 | P2 | P3 |
|---|---|---|---|
| SG1 | 8000.0 | 11.0 | 546.0 |
| SG2 | 8009.5 | 11.0 | 540.5 |
| SG3 | 8009.5 | 11.0 | 540.5 |
| SG4 | 8003.0 | 11.0 | 539.5 |
| SG5 | 8000.0 | 10.5 | 539.5 |
| SG6 | 7997.0 | 11.5 | 537.0 |
| average | 8003.17 | 11.0 | 540.50 |
| standard | 5.26 | 0.32 | 2.98 |
| deviation | | | |

Covariance Matrix

| | P1 | P2 | P3 |
|---|---|---|---|
| P1 | 27.67 | −0.30 | 1.50 |
| P2 | −0.30 | 0.10 | −0.25 |
| P3 | 1.50 | −0.25 | 8.90 |

Covariance Inverse Matrix

| | P1 | P2 | P3 |
|---|---|---|---|
| P1 | 0.04 | 0.10 | 0.00 |
| P2 | 0.10 | 11.04 | 0.29 |
| P3 | 0.00 | 0.29 | 0.12 |

(c) Average, Standard Deviation, Covariance Matrix, and Covariance Inverse Matrix for m=11 to 12

### INDUSTRIAL APPLICABILITY

As described above, according to an embodiment of the present invention, delicate variations of an equipment can be detected sensitively to improve the function of fault detection, and major variation components of a step in which the most severe variations occur actually can be precisely acquired and classified, thereby a basic function of fault detection and classification (FDC) can be precisely performed. In addition, the present invention can be applied to monitoring of variations of parameters requiring precise control including monitoring delicate variations of process parameters and monitoring for getting off normal values of parameters in transient states.

1. A method of fault detection and classification in semiconductor manufacturing, the method comprising steps of:
a first step for collecting reference data of all subgroups for each step of a process recipe;
a second step for calculating averages, standard deviations, variances, covariance matrixes, and covariance inverse matrixes of the reference data;
a third step for collecting the reference data by calculating Hotelling's T-square values and UCLs (upper control limit) of the reference data;
a fourth step checking variations of newly observed data with respect to the reference data by calculating Hotelling's T-square values and UCLs of the newly observed data; and
a fifth step for acquiring major components of variations for each step through a decomposition process.

2. The method according to claim 1, wherein the variances and covariances have non-zero values by adding or subtracting a small value that does not have a substantial effect on the original value to arbitrary one of the subgroups when a parameter has same values for all the subgroups.

3. The method according to claim 1, wherein values of the covariance inverse matrix are set to zero to eliminate an effect of a parameter completely, when the parameter has same values for all the subgroups.

4. The method according to claim 1, wherein the calculating of Hotelling's T-square values in the third step comprises removing reference data of which the T-square value is larger than the UCL and calculating an average, a standard deviation, a variance, a covariance matrix, a covariance inverse matrix of the reference data for each step to be used as the reference data.

5. The method according to claim 1, wherein the variations for each step in the fifth step are detected by acquiring unconditional terms and conditional terms through a decomposition process.
